(19) United States
(12) Patent Application Publication
(10) Pub. No.: US 2022/0322485 A1
(43) Pub. Date: Oct. 6, 2022

(54) DISCONTINUOUS RECEPTION METHOD AND APPARATUS, ELECTRONIC DEVICE AND COMPUTER READABLE STORAGE MEDIUM

(71) Applicant: Beijing Xiaomi Mobile Software Co., Ltd., Beijing (CN)

(72) Inventor: Yanhua LI, Beijing (CN)

(21) Appl. No.: 17/595,829

(22) PCT Filed: May 27, 2019
(86) PCT No.: PCT/CN2019/088668

§ 371 Date: Nov. 24, 2021

(51) Int. Cl. H04W 76/28; H04W 24/08

(52) U.S. Cl. CPC H04W 76/28; H04W 24/08; H04W 80/02

(57) ABSTRACT

A discontinuous reception method can include: monitoring a downlink channel in a discontinuous reception long cycle according to a first monitoring parameter; determining a second monitoring parameter when entering into a discontinuous reception short cycle in the discontinuous reception long cycle; and monitoring the downlink channel according to the second monitoring parameter. A duration of each monitoring according to the second monitoring parameter can be different from a duration of each monitoring according to the first monitoring parameter.

### TECHNICAL FIELD

The disclosure relates to the technical field of communication, in particular to a discontinuous reception method and apparatus, electronic device and a computer readable storage medium.

### BACKGROUND AND SUMMARY

In a connected state, user equipment may stop monitoring of a downlink channel within a time period according to a discontinuous reception (DRX) mechanism, so as to save power.

As shown in FIG. 1, in a DRX cycle, the user equipment monitors the downlink channel at an On Duration time period, and the user equipment does not monitor the downlink channel at an Opportunity for DRX time period.

A duration of the On Duration time period is determined mainly according to a monitoring parameter of an Onduration Timer. However, in some cases, the On Duration time period may further need to be prolonged, and a duration needing to be prolonged is determined according to a monitoring parameter of a drx-Inactivity Timer.

In an actual discontinuous reception process, the discontinuous reception cycle includes a discontinuous reception long cycle and a discontinuous reception short cycle, and the discontinuous reception short cycle is comprised in the discontinuous reception long cycle.

According to a first aspect of the disclosure, a discontinuous reception method is provided, applied to user equipment, and includes:

monitoring a downlink channel in a discontinuous reception long cycle according to a first monitoring parameter;

determining a second monitoring parameter when entering into a discontinuous reception short cycle in the long cycle; and

monitoring the downlink channel in the short cycle according to the second monitoring parameter.

A duration of each monitoring according to the second monitoring parameter is different from a duration of each monitoring according to the first monitoring parameter.

According to a second aspect of the disclosure, an electronic device is provided, and includes:

a processor; and

a memory configured for storing executable instructions of the processor.

The processor is configured to:

monitor a downlink channel in a discontinuous reception long cycle according to a first monitoring parameter;

determine a second monitoring parameter when entering into a discontinuous reception short cycle in the long cycle; and

monitor the downlink channel in the short cycle according to the second monitoring parameter, in which a duration of each monitoring according to the second monitoring parameter is different from a duration of each monitoring according to the first monitoring parameter.

According to a third aspect of the disclosure, a non-transitory computer readable storage medium is provided, and stores a computer program. The program, when executed by a processor, implements steps in the discontinuous reception method according to any above example.

### BRIEF DESCRIPTION OF THE DRAWINGS

In order to illustrate the technical solutions in the examples of the disclosure more clearly, drawings needing to be used in description of the examples will be introduced below briefly. Obviously, the drawings in the description below are only some examples of the disclosure, and those skilled in the art can further obtain other drawings according to these drawings without inventive efforts.

FIG. 1 is a schematic diagram of a discontinuous reception cycle in the related art.

FIG. 2 is a schematic flow diagram of a discontinuous reception method shown according to an example of the disclosure.

FIG. 3 is a schematic diagram of durations of monitoring by user equipment in a discontinuous reception long cycle and a discontinuous reception short cycle in the related art.

FIG. 4 is a schematic diagram of durations of monitoring in a discontinuous reception long cycle and a discontinuous reception short cycle shown according to an example of the disclosure.

FIG. 5 is a schematic diagram of another durations of monitoring in a discontinuous reception long cycle and a discontinuous reception short cycle shown according to an example of the disclosure.

FIG. 6 is a schematic diagram of further durations of monitoring in a discontinuous reception long cycle and a discontinuous reception short cycle shown according to an example of the disclosure.

FIG. 7 is a schematic flow diagram of another discontinuous reception method shown according to an example of the disclosure.

FIG. 8 is a schematic flow diagram of further discontinuous reception method shown according to an example of the disclosure.

FIG. 9 is a schematic flow diagram of further discontinuous reception method shown according to an example of the disclosure.

FIG. 10 is a schematic flow diagram of further discontinuous reception method shown according to an example of the disclosure.

FIG. 11 is a schematic flow diagram of further discontinuous reception method shown according to an example of the disclosure.

FIG. 12 is a schematic flow diagram of further discontinuous reception method shown according to an example of the disclosure.

FIG. 13 is a schematic flow diagram of further discontinuous reception method shown according to an example of the disclosure.

FIG. 14 is a schematic block diagram of a discontinuous reception apparatus shown according to an example of the disclosure.

FIG. 15 is a schematic block diagram of another discontinuous reception apparatus shown according to an example of the disclosure.

FIG. 16 is a schematic block diagram of further discontinuous reception apparatus shown according to an example of the disclosure.

FIG. 17 is a schematic block diagram of a parameter determining module shown according to an example of the disclosure.

FIG. 18 is a schematic block diagram of an apparatus for data sending shown according to an example of the disclosure.

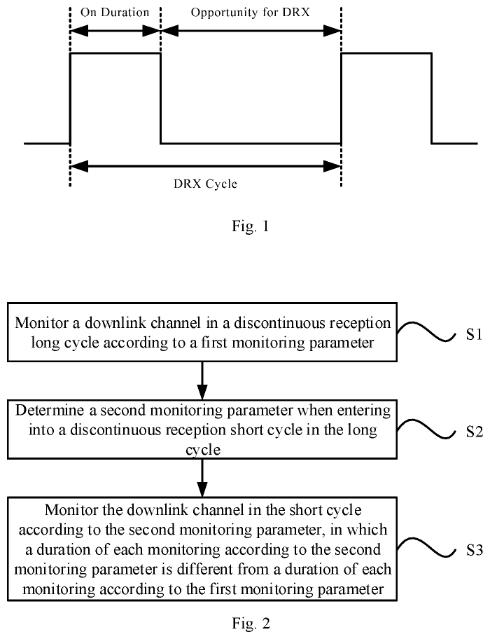

### DETAILED DESCRIPTION

The technical solutions in the examples of the disclosure will be described clearly and completely with reference to the drawings in the examples of the disclosure. The described examples are only part of the examples of the disclosure, but not all the examples. On the basis of the examples in the disclosure, all other examples obtained by those skilled in the art without inventive efforts fall within the protection scope of the disclosure.

In the related art, because the discontinuous reception short cycle is comprised in the discontinuous reception long cycle, a monitoring parameter set for the discontinuous reception short cycle is the same as a monitoring parameter set for the discontinuous reception long cycle, so that a duration of monitoring by the user equipment in the discontinuous reception long cycle according to the monitoring parameter is the same as a duration of monitoring by the user equipment in the discontinuous reception short cycle according to the monitoring parameter, which greatly limits flexibility of performing a monitoring operation.

FIG. 2 is a schematic flow diagram of a discontinuous reception method shown according to an example of the disclosure. The discontinuous reception method shown by the example of the disclosure may be applied to user equipment, the user equipment may be in communication with a base station based on, for example, a 4G technology, or a 5G technology. The user equipment includes but is not limited to a mobile phone, a tablet computer, wearable equipment, and other electronic device.

As shown in FIG. 2, the discontinuous reception method may include the following steps:

in step S1, a downlink channel is monitored in a discontinuous reception long cycle according to a first monitoring parameter.

In one example, the downlink channel monitored by the user equipment may be a physical downlink control channel (PDCCH).

In step S2, a second monitoring parameter is determined when entering into a discontinuous reception short cycle in the long cycle.

The first monitoring parameter and the second monitoring parameter may be a duration of an Onduration Timer, or a duration of a discontinuous timer.

In one example, the second monitoring parameter may be received from a base station. For example, the second monitoring parameter may be obtained from a radio resource control message sent by the base station, and/or a control element of a medium access control layer.

In one example, the second monitoring parameter may be determined by the user equipment on its own. For example, the second monitoring parameter may be determined according to a preset numerical value, the second monitoring parameter is a duration of a second Onduration Timer, the preset numerical value may be a duration of an On Duration time period in the short cycle, such as 10 milliseconds, then the duration of the second Onduration Timer may be set, so that the duration of the On Duration time period in the short cycle is 10 milliseconds. For example, the second monitoring parameter may be determined according to a preset proportion and the first monitoring parameter. The first monitoring parameter is a duration of a first Onduration Timer, the preset proportion is ½, and then the duration of the second Onduration Timer may be set, so that a duration, determined by the user equipment according to the duration of the second Onduration Timer, of the On Duration time period is equal to ½ of a duration, determined by the user equipment according to the duration of the first Onduration Timer, of the On Duration time period.

In step S3, the downlink channel is monitored in the short cycle according to the second monitoring parameter.

A duration of each monitoring according to the second monitoring parameter is different from a duration of each monitoring according to the first monitoring parameter.

According to the examples of the disclosure, the duration that the user equipment monitors the downlink channel in the discontinuous reception short cycle may be different from the duration that the user equipment monitors the downlink channel in the discontinuous reception long cycle when not entering into the discontinuous reception short cycle, and the user equipment is convenient to flexibly configure to monitor the downlink channel.

In one example, the discontinuous reception short cycle is comprised in the discontinuous reception long cycle. When monitoring the downlink channel according to a discontinuous reception mechanism, the user equipment enters into the discontinuous reception long cycle firstly, and monitors the downlink channel according to the first monitoring parameter of the discontinuous reception long cycle. When entering into the discontinuous reception short cycle in the discontinuous reception long cycle, the user equipment enters into the discontinuous reception short cycle to monitor the downlink channel.

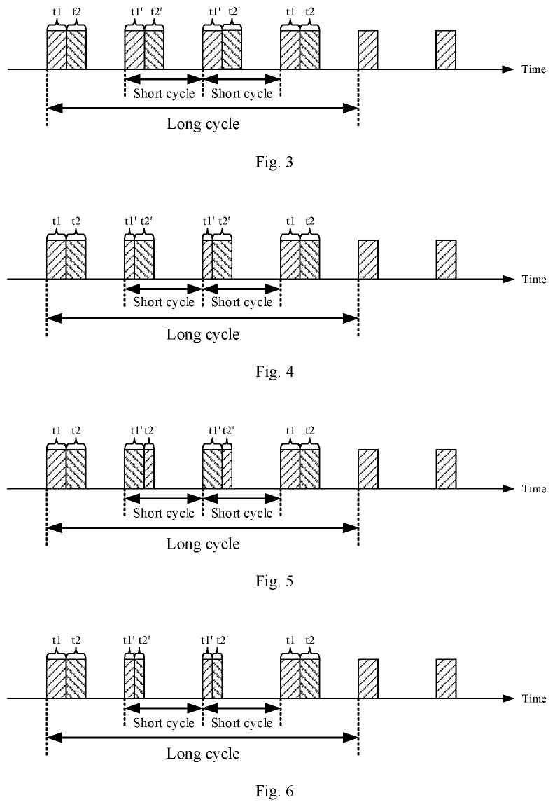

FIG. 3 is a schematic diagram of durations of monitoring by the user equipment in the discontinuous reception long cycle and the discontinuous reception short cycle in the related art.

As shown in FIG. 3, the duration of each monitoring by the user equipment in the discontinuous reception long cycle is t1+t2, t1 is the duration of the On Duration time period determined according to the Onduration Timer of the discontinuous reception long cycle, and t2 is a duration for prolonging the On Duration time period and determined according to a drx-Inactivity Timer of the discontinuous reception long cycle.

The duration of each monitoring by the user equipment in the discontinuous reception short cycle is t1′+t2′, t1′ is the duration of the On Duration time period determined according to the Onduration Timer of the discontinuous reception short cycle, and t2′ is a duration for prolonging the On Duration time period and determined according to a drx-Inactivity Timer of the discontinuous reception short cycle.

As shown in FIG. 3, in the related art, t1=t1′, and t2=t2′.

According to the example of the disclosure, the duration of each monitoring by the user equipment in the discontinuous reception short cycle according to the second monitoring parameter is different from a duration of each monitoring by the user equipment according to the first monitoring parameter in the discontinuous reception long cycle when not entering into the discontinuous reception short cycle.

FIG. 4 is a schematic diagram of durations of monitoring in the discontinuous reception long cycle and the discontinuous reception short cycle shown according to an example of the disclosure.

In one example, the second Onduration Timer based by the user equipment when monitoring the downlink channel in the discontinuous reception short cycle is different from the first Onduration Timer based by the user equipment when monitoring the downlink channel in the discontinuous reception long cycle and not entering into the discontinuous reception short cycle (mainly refers to that the duration of the first Onduration Timer and the duration of the second Onduration Timer are different).

In this case, as shown in FIG. 4, the duration t1′ of the On Duration time period of monitoring the downlink channel by the user equipment in the discontinuous reception short cycle is different from the duration t1 of the On Duration time period of monitoring the downlink channel by the user equipment in the discontinuous reception long cycle when not entering into the discontinuous reception short cycle, for example, t1′ is smaller than t1, but t2=t2′. Then a duration t1′+t2′ of each monitoring by the user equipment in the discontinuous reception short cycle according to the second monitoring parameter is different from a duration t1+t2 of each monitoring by the user equipment according to the first monitoring parameter in the discontinuous reception long cycle when not entering into the discontinuous reception short cycle.

FIG. 5 is a schematic diagram of another durations of monitoring in the discontinuous reception long cycle and the discontinuous reception short cycle shown according to an example of the disclosure.

In one example, a second drx-Inactivity Timer based by the user equipment when monitoring the downlink channel in the discontinuous reception short cycle is different from the first drx-Inactivity Timer based by the user equipment when monitoring the downlink channel in the discontinuous reception long cycle and not entering into the discontinuous reception short cycle (mainly refers to that a duration of the first drx-Inactivity Timer and a duration of the second drx-Inactivity Timer are different).

In this case, as shown in FIG. 5, a duration t2′ for prolonging the On Duration time period of monitoring the downlink channel by the user equipment in the discontinuous reception short cycle is different from a duration t2 for prolonging the On Duration time period of monitoring the downlink channel by the user equipment in the discontinuous reception long cycle when not entering into the discontinuous reception short cycle, for example, t2′ is smaller than t2, but t1=t1′. Then the duration t1′+t2′ of each monitoring by the user equipment in the discontinuous reception short cycle according to the second monitoring parameter is different from the duration t1+t2 of each monitoring by the user equipment according to the first monitoring parameter in the discontinuous reception long cycle when not entering into the discontinuous reception short cycle.

FIG. 6 is a schematic diagram of further durations of monitoring in the discontinuous reception long cycle and the discontinuous reception short cycle shown according to an example of the disclosure.

In one example, the second Onduration Timer based by the user equipment when monitoring the downlink channel in the discontinuous reception short cycle is different from the first Onduration Timer based by the user equipment when monitoring the downlink channel in the discontinuous reception long cycle and not entering into the discontinuous reception short cycle. The second drx-Inactivity Timer based by the user equipment when monitoring the downlink channel in the discontinuous reception short cycle is different from the first drx-Inactivity Timer based by the user equipment when monitoring the downlink channel in the discontinuous reception long cycle and not entering into the discontinuous reception short cycle.

Then as shown in FIG. 6, t1 may be different from t1′, for example, t1′ is smaller than t1. t2 may be different from t2′, for example, t2′ is smaller than t2, and then t1+t2 is different from t1′+t2′.

According to the example of the disclosure, the duration that the user equipment monitors the downlink channel in the discontinuous reception short cycle may be different from the duration that the user equipment monitors the downlink channel in the discontinuous reception long cycle when not entering into the discontinuous reception short cycle, and the user equipment is convenient to flexibly configure to monitor the downlink channel. For example, a stop moment of monitoring the downlink channel by the user equipment in the discontinuous reception short cycle may be set as required, and a monitoring operation is not limited to be stopped according to the duration of monitoring the downlink channel in the discontinuous reception long cycle.

It should be noted that in the example of the disclosure, the quantity of the short cycles comprised by the long cycle may be specifically set as required, and is not limited to the cases shown in the above schematic diagrams. An opportunity and the number of times when the user equipment enters into the discontinuous reception short cycle in the long cycle may be specifically set as required, and is not limited to the cases shown in the above schematic diagrams. Each monitoring of the user equipment may only last the duration of the On Duration time period, or prolongs a duration on the basis of lasting the duration of the On Duration time period, which may be specifically set as required, and is not limited to the cases shown in the above schematic diagrams.

Optionally, the duration of each monitoring according to the second monitoring parameter is shorter than the duration of each monitoring according to the first monitoring parameter.

In one example, the longer the duration of monitoring is, the longer of a working time of the user equipment needs to be, and the more the power consumption is. By setting that the duration of each monitoring according to the second monitoring parameter is shorter than the duration of each monitoring according to the first monitoring parameter, the duration of each monitoring by the user equipment in the discontinuous reception short cycle according to the second monitoring parameter may be shorter than the duration of each monitoring by the user equipment according to the first monitoring parameter in the discontinuous reception long cycle when not entering into the discontinuous reception short cycle, so that the power consumption of monitoring the downlink channel by the user equipment in the short cycle is reduced, so as to further reduce power consumption of the user equipment under a whole discontinuous reception state.

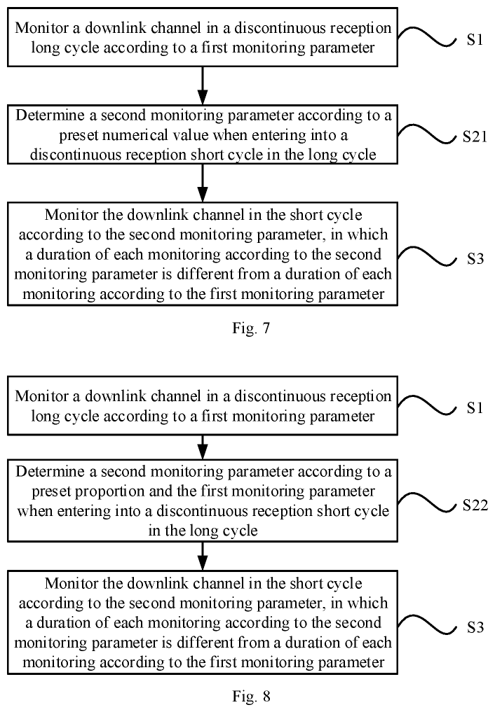

FIG. 7 is a schematic flow diagram of another discontinuous reception method shown according to an example of the disclosure. As shown in FIG. 7, determining the second monitoring parameter when entering into the discontinuous reception short cycle in the long cycle includes:

in step S21, the second monitoring parameter is determined according to a preset numerical value when entering into the discontinuous reception short cycle in the long cycle.

In one example, the second monitoring parameter may be determined according to the preset numerical value.

For example, the second monitoring parameter is a duration of a second Onduration Timer, the preset numerical value may be a duration of an On Duration time period, such as 10 milliseconds, then the duration of the second Onduration Timer may be set, so that the duration of the On Duration time period is 10 milliseconds.

For example, the second monitoring parameter is a duration of a second drx-Inactivity Timer, the preset numerical value may be a duration for prolonging the On Duration time period, such as 5 milliseconds, then the duration of the second drx-Inactivity Timer may be set, so that the duration for prolonging the On Duration time period is 5 milliseconds.

FIG. 8 is a schematic flow diagram of further discontinuous reception method shown according to an example of the disclosure. As shown in FIG. 8, determining the second monitoring parameter when entering into the discontinuous reception short cycle in the long cycle includes:

in step S22, the second monitoring parameter is determined according to a preset proportion and the first monitoring parameter when entering into the discontinuous reception short cycle in the long cycle.

In one example, the second monitoring parameter may be determined according to the preset proportion and the first monitoring parameter.

For example, the first monitoring parameter is a duration of a first Onduration Timer, the preset proportion is ½, and then the duration of the second Onduration Timer may be set, so that a duration, determined by the user equipment according to the duration of the second Onduration Timer, of the On Duration time period is equal to ½ of a duration, determined by the user equipment according to the duration of the first Onduration Timer, of the On Duration time period.

For example, the first monitoring parameter is a duration of a first drx-Inactivity Timer, the preset proportion is ⅕, and then the duration of the second drx-Inactivity Timer may be set, so that a duration for prolonging the On Duration time period and determined by the user equipment according to the duration of the second drx-Inactivity Timer is equal to ⅕ of a duration for prolonging the On Duration time period and determined by the user equipment according to the duration of the first drx-Inactivity Timer.

Optionally, the first monitoring parameter and the second monitoring parameter include at least one of:

the duration of the Onduration Timer, or the duration of the drx-Inactivity Timer.

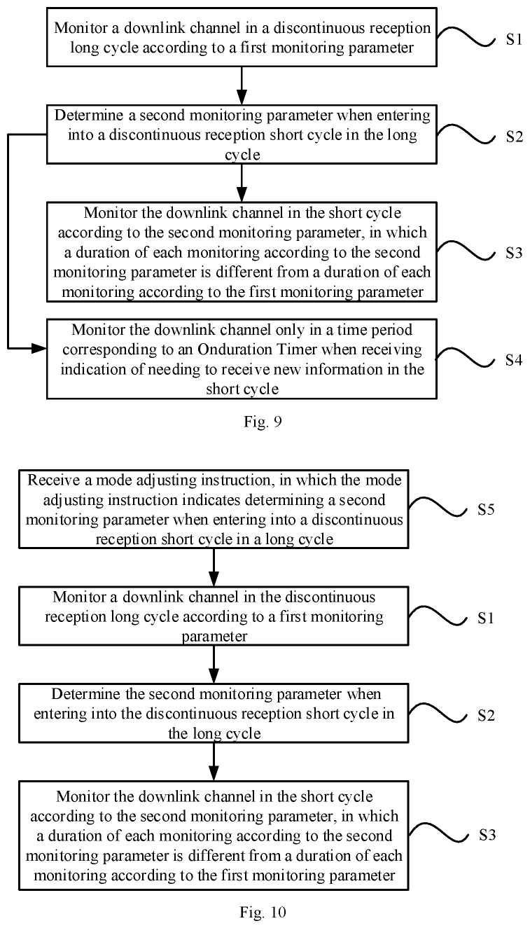

FIG. 9 is a schematic flow diagram of further discontinuous reception method shown according to an example of the disclosure. As shown in FIG. 9, the second monitoring parameter includes the duration of the Onduration Timer, and the method further includes:

in step S4, the downlink channel is monitored only in a time period corresponding to the Onduration Timer when receiving indication of needing to receive new information in the short cycle.

In the related art, under a discontinuous reception state, when the user equipment receives the indication of needing to receive the new information (DCI for new transmission) either in the long cycle or in the short cycle, the On Duration time period needs to be prolonged according to the drx-Inactivity Timer.

However, in the present example, when the user equipment receives the indication of needing to receive the new information in the short cycle, the downlink channel is monitored only in the time period corresponding to the Onduration Timer, namely in the On Duration time period, and the On Duration time period is not prolonged according to the drx-Inactivity Timer. In this way, the duration of monitoring the downlink channel by the user equipment may be reduced, so as to reduce the power consumption of the user equipment.

FIG. 10 is a schematic flow diagram of further discontinuous reception method shown according to an example of the disclosure. As shown in FIG. 10, before monitoring the downlink channel in the discontinuous reception long cycle according to the first monitoring parameter, the method further includes:

in step S5, a mode adjusting instruction is received, and the mode adjusting instruction indicates determining the second monitoring parameter when entering into the discontinuous reception short cycle in the long cycle.

In one example, step S2 and the subsequent steps may only be executed according to the above example in a case of receiving the mode adjusting instruction, and the second monitoring parameter is determined when entering into the discontinuous reception short cycle in the long cycle. In a case of not receiving the mode adjusting instruction, the downlink channel may be monitored still according to the first monitoring parameter when entering into the discontinuous reception short cycle in the long cycle. In this way, a case of adopting the second monitoring parameter in the discontinuous reception short cycle may be set as an optional mode, so that a user selects as required.

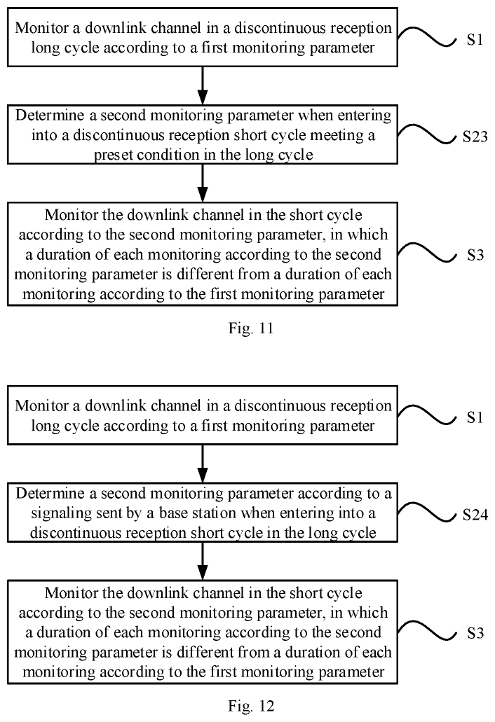

FIG. 11 is a schematic flow diagram of further discontinuous reception method shown according to an example of the disclosure. As shown in FIG. 11, the long cycle comprises the plurality of short cycles, and determining the second monitoring parameter when entering into the discontinuous reception short cycle in the long cycle includes:

in step S23, the second monitoring parameter is determined when entering into a discontinuous reception short cycle meeting a preset condition in the long cycle.

In one example, entering the short cycle may be achieved in the long cycle under various conditions, for example, entering the short cycle may be achieved after timeout of the drx-Inactivity Timer, or entering the short cycle may be achieved after receiving a control element of a medium access control layer (MAC CE). By setting that the step S2 of determining the second monitoring parameter and the subsequent steps are only executed according to the above example when entering into the discontinuous reception short cycle meeting the preset condition in the long cycle, the short cycle when the user equipment determines the second monitoring parameter may be adjusted by setting the preset condition, and the short cycle of monitoring the downlink channel according to the second monitoring parameter is conveniently selected.

Optionally, the discontinuous reception short cycle meeting the preset condition includes at least one of:

the short cycle after timeout of the drx-Inactivity Timer, or the short cycle after receiving the control element of the medium access control layer. The preset condition may also be set as required except for the above two kinds.

FIG. 12 is a schematic flow diagram of further discontinuous reception method shown according to an example of the disclosure. As shown in FIG. 12, determining the second monitoring parameter when entering into the discontinuous reception short cycle in the long cycle includes:

in step S24, the second monitoring parameter is determined according to a signaling sent by a base station when entering into the discontinuous reception short cycle in the long cycle.

The signaling is comprised in at least one of:

a radio resource control (RRC) message, or a control element of a medium access control layer (MAC CE).

In one example, the base station may indicate the second monitoring parameter to the user equipment by sending the radio resource control message, or indicate the second monitoring parameter to the user equipment by sending the control element of the medium access control layer, which may be specifically set as required.

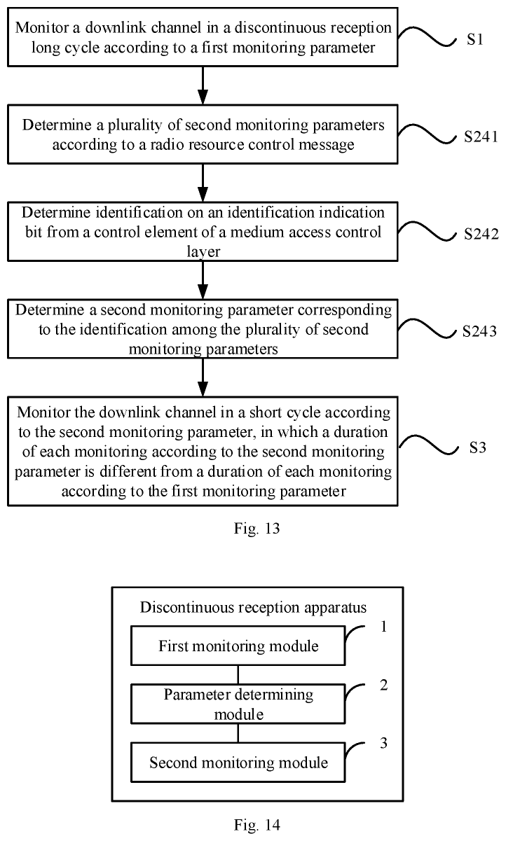

FIG. 13 is a schematic flow diagram of further discontinuous reception method shown according to an example of the disclosure. As shown in FIG. 13, the signaling is comprised in the radio resource control message and the control element of the medium access control layer, and determining the second monitoring parameter according to the signaling sent by the base station includes:

in step S241, a plurality of second monitoring parameters are determined according to the radio resource control message;

in step S242, identification on an identification indication bit is determined from the control element of the medium access control layer; and

in step S243, the second monitoring parameter corresponding to the identification is determined among the plurality of second monitoring parameters.

In one example, the base station may indicate the second monitoring parameter to the user equipment through both the radio resource control message and the control element of the medium access control layer. The identification may be set on the identification indication bit of the control element of the medium access control layer, and the identification indicates which parameter in the plurality of second monitoring parameters of the radio resource control message is the second monitoring parameter applied to the user equipment, the user equipment may determine the identification on the identification indication bit from the received control element of the medium access control layer, and then determine the second monitoring parameter corresponding to the identification among the plurality of second monitoring parameters, namely, the second monitoring parameter applied to the user equipment.

The disclosure further disclosures examples of a discontinuous reception apparatus corresponding to the above examples of the discontinuous reception method.

FIG. 14 is a schematic block diagram of a discontinuous reception apparatus shown according to an example of the disclosure. The discontinuous reception apparatus shown according to the example of the disclosure may be applied to the user equipment. The user equipment may be in communication with a base station based on, for example, a 4G technology, or a 5G technology. The user equipment includes but is not limited to a mobile phone, a tablet computer, wearable equipment, and other electronic equipment.

As shown in FIG. 14, the discontinuous reception apparatus may include:

a first monitoring module 1, configured to monitor a downlink channel in a discontinuous reception long cycle according to a first monitoring parameter;

a parameter determining module 2, configured to determine a second monitoring parameter when entering into a discontinuous reception short cycle in the long cycle; and

a second monitoring module 3, configured to monitor the downlink channel in the short cycle according to the second monitoring parameter.

A duration of each monitoring according to the second monitoring parameter is different from a duration of each monitoring according to the first monitoring parameter.

Optionally, the duration of each monitoring according to the second monitoring parameter is shorter than the duration of each monitoring according to the first monitoring parameter.

Optionally, the parameter determining module is configured to determine the second monitoring parameter according to a preset numerical value when entering into the discontinuous reception short cycle in the long cycle.

Optionally, the parameter determining module is configured to determine the second monitoring parameter according to a preset proportion and the first monitoring parameter when entering into the discontinuous reception short cycle in the long cycle.

Optionally, the first monitoring parameter and the second monitoring parameter include at least one of:

a duration of an Onduration Timer, or a duration of a drx-Inactivity Timer.

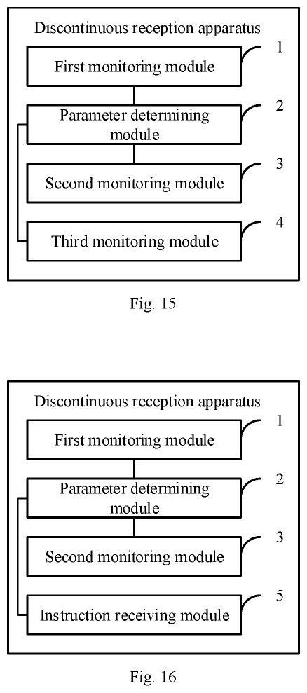

FIG. 15 is a schematic block diagram of another discontinuous reception apparatus shown according to an example of the disclosure. As shown in FIG. 15, the second monitoring parameter includes the duration of the Onduration Timer, and the apparatus further includes:

a third monitoring module 4, configured to monitor the downlink channel only in a time period corresponding to the Onduration Timer when receiving indication of needing to receive new information in the short cycle.

FIG. 16 is a schematic block diagram of further discontinuous reception apparatus shown according to an example of the disclosure. As shown in FIG. 16, the apparatus further includes:

an instruction receiving module 5, configured to receive a mode adjusting instruction. The mode adjusting instruction indicates determining the second monitoring parameter when entering into the discontinuous reception short cycle in the long cycle.

Optionally, the long cycle comprises the plurality of short cycles, and the parameter determining module is configured to determine the second monitoring parameter when entering into a discontinuous reception short cycle meeting a preset condition in the long cycle.

Optionally, the discontinuous reception short cycle meeting the preset condition includes at least one of:

a short cycle after timeout of a drx-Inactivity Timer, or a short cycle after receiving a control element of a medium access control layer.

Optionally, the parameter determining module is configured to determine the second monitoring parameter according to a signaling sent by a base station when entering into the discontinuous reception short cycle in the long cycle.

The signaling is comprised in at least one of:

a radio resource control message, or a control element of a medium access control layer.

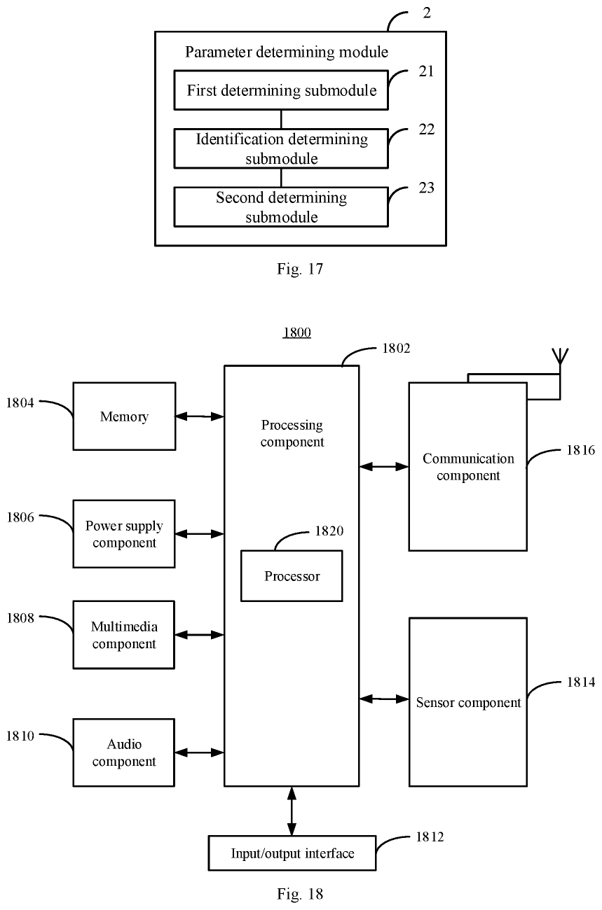

FIG. 17 is a schematic block diagram of a parameter determining module shown according to an example of the disclosure. As shown in FIG. 17, the signaling is comprised in the radio resource control message and the control element of the medium access control layer, and the parameter determining module 2 includes:

a first determining submodule 21, configured to determine a plurality of second monitoring parameters according to the radio resource control message;

an identification determining submodule 22, configured to determine identification on an identification indication bit from the control element of the medium access control layer; and

a second determining submodule 23, configured to determine the second monitoring parameter corresponding to the identification among the plurality of second monitoring parameters.

As for the apparatus in the above example, specific modes for executing the operation by all modules have been described in detail in the example of the related method, which will not be illustrated in detail here.

The example of the apparatus substantially corresponds to the example of the method, so related description may refer to parts of description of the example of the method. The example of the apparatus described above is only schematic, a module described as a separate part may be or may not be physically separate, a part displayed as the module may be or may not be a physical module, that is, the part may be located at one place, or may be distributed onto a plurality of network modules. Partial or all modules may be selected according to actual needs to implement the objective of the solutions of the present example. Those skilled in the art may understand and implement without creative effort.

An example of the disclosure further provides electronic equipment, including:

a processor; and

a memory configured for storing executable instructions of the processor.

The processor is configured to implement a discontinuous reception method according to any above example.

An example of the disclosure further provides a computer readable storage medium, storing a computer program. The program, when executed by a processor, implements steps in a discontinuous reception method according to any above example.

FIG. 18 is a schematic block diagram of an apparatus 1800 for data sending shown according to an example of the disclosure. For example, the apparatus 1800 may be a mobile phone, a computer, a digital broadcast terminal, message transceiving equipment, a games console, tablet equipment, medical equipment, fitness equipment, a personal digital assistant, and the like.

Referring to FIG. 18, the apparatus 1800 may include one or more of the following components: a processing component 1802, a memory 1804, a power supply component 1806, a multimedia component 1808, an audio component 1810, an input/output (I/O) interface 1812, a sensor component 1814, and a communication component 1816.

The processing component 1802 generally controls an overall operation of the apparatus 1800, such as operations associated with display, telephone call, data communication, camera operation and record operation. The processing component 1802 may include one or more processors 1820 to execute instructions so as to complete all or part of steps of the above method. In addition, the processing component 1802 may include one or more modules, facilitating interaction between the processing component 1802 and other components. For example, the processing component 1802 may include a multimedia module, so as to facilitate interaction between the multimedia component 1808 and the processing component 1802.

The memory 1804 is configured to store various types of data so as to support the operation on the apparatus 1800. Examples of these data include instructions of any application program or method used to be operated on the apparatus 1800, contact data, telephone directory data, a message, a picture, a video, and the like. The memory 1804 may be implemented by any type of volatile or nonvolatile storage device or their combination, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disc or an optical disc.

The power supply component 1806 provides electric power for various components of the apparatus 1800. The power supply component 1806 may include a power source management system, one or more power sources, and other components associated with generating, managing and distributing the electric power for the apparatus 1800.

The multimedia component 1808 includes a screen providing an output interface between the apparatus 1800 and a user. In some examples, the screen may include a liquid crystal display (LCD) and a touch panel (TP). If the screen includes the touch panel, the screen may be implemented as a touch screen, so as to receive an input signal from the user. The touch panel includes one or more touch sensors so as to sense touch, sliding or gestures on the touch panel. The touch sensor may sense a boundary of a touch or a sliding motion, and further detects a duration and pressure related to the touch or the sliding operation. In some examples, the multimedia component 1808 includes a front camera and/or a rear camera. When the apparatus 1800 is in an operation mode, such as a shooting mode or a video mode, the front camera and/or the rear camera may receive external multimedia data. Each of the front camera and the rear camera may be a fixed optical lens system or has a focal length and optical zoom capability

The audio component 1810 is configured to output and/or input an audio signal. For example, the audio component 1810 includes a microphone (MIC), and when the apparatus 1800 is in an operation mode, such as a calling mode, a record mode and a voice recognition mode, the microphone is configured to receive an external audio signal. The received audio signal may be further stored in the memory 1804 or be sent via the communication component 1816. In some examples, the audio component 1810 further includes a loudspeaker configured to output the audio signal.

The I/O interface 1812 provides an interface between the processing component 1802 and a peripheral interface module, and the above peripheral interface module may be a keyboard, a click wheel, buttons, and the like. The buttons include but are not limited to: a home button, a volume button, a start button and a locking button.

The sensor component 1814 includes one or more sensors, and is configured to provide various aspects of state evaluation for the apparatus 1800. For example, the sensor component 1814 may detect an on/off state of the apparatus 1800, and relative positioning of the components, for example, the component is a display and a keypad of the apparatus 1800. The sensor component 1814 may further detect the apparatus 1800 or detect location change of one component of the apparatus 1800, presence or absence of contact between a user and the apparatus 1800, orientation or acceleration/deceleration of the apparatus 1800, and temperature change of the apparatus 1800. The sensor component 1814 may include a proximity detector, configured to detect presence of a nearby object in the absence of any physical contact. The sensor component 1814 may further include an optical sensor, such as a CMOS or a CCD image sensor, configured to be used in imaging application. In some examples, the sensor component 1814 may further include an acceleration sensor, a gyroscope sensor, a magnetic sensor, a pressure sensor or a temperature sensor.

The communication component 1816 is configured to facilitate wired or wireless communication between the apparatus 1800 and other equipment. The apparatus 1800 may have access to a wireless network based on a communication standard, such as WiFi, 2G or 3G, 4G LTE, 5G NR or their combinations. In one example, the communication component 1816 receives a broadcast signal or broadcast related information from an external broadcast management system through a broadcast channel In one example, the communication component 1816 further includes a near-field communication (NFC) module, so as to promote short-range communication. For example, the NFC module may be realized on the basis of a radio frequency identification (RFID) technology, an infrared data association (IrDA) technology, an ultra wide band (UWB) technology, a Bluetooth (BT) technology and other technologies.

In the example, the apparatus 1800 may be implemented by one or more application specific integrated circuits (ASIC), digital signal processors (DSP), digital signal processing devices (DSPD), programmable logic devices (PLD), field-programmable gate arrays (FPGA), controllers, microcontrollers, microprocessors or other electronic elements, and configured to execute the above method in any example.

In the example, a non-temporary computer readable storage medium including instructions is further provided, for example, a memory 1804 including the instructions, and the above instructions may be executed by the processor 1820 of the apparatus 1800 so as to complete the above method. For example, the non-temporary computer readable storage medium may be an ROM, a random access memory (RAM), a CD-ROM, a magnetic tape, a floppy disk, optical data storage equipment, and the like.

Those skilled in the art will easily think of other implementation solutions of the disclosure after considering the specification and practicing the disclosure disclosed herein. The disclosure is intended to cover any variations, uses, or adaptive changes of the disclosure. These variations, uses, or adaptive changes follow the general principles of the disclosure and include common knowledge or conventional technical means, not disclosed in the disclosure, in the present technical field. The specification and the examples are only regarded as illustrative, and the true range and spirit of the disclosure are pointed out by the following claims.

It should be understood that the disclosure is not limited to the precise structure described above and shown in the drawings, and various modifications and changes may be made without departing from its scope. The scope of the disclosure is only limited by the attached claim.

It should be noted that relationship terms such as first and second herein are only used for distinguishing one entity or operation from another entity or operation, and may be not intended to require or suggest that there is any actual relationship or order between these entities or operations. The terms “include”, “comprise” or any other variants of them are intended to cover non-exclusive containing, so that a process, a method, an article or a device containing a series of elements include those elements, and further include other elements not listed clearly, or further include inherent elements of such process, method, article or device. In the case without more limitation, the elements defined by the statement “includes a . . . ” do not exclude the other same elements still existing in the process, the method, the article or the device including the elements.

The methods and apparatuses provided by the examples of the disclosure are introduced above in detail, specific examples are applied herein to elaborate the principles and implementations of the disclosure, and description of the above examples are only used for helping to understand the method of the disclosure and its core thought. Meanwhile, for those skilled in the art, the specific implementation and the application scope will be changed according to the thought of the disclosure. In conclusion, the contents of the present specification should not be understood as limitation to the disclosure.

1. A discontinuous reception method, applied to user equipment, and comprising:
monitoring a downlink channel in a discontinuous reception long cycle according to a first monitoring parameter;
determining a second monitoring parameter when entering into a discontinuous reception short cycle in the discontinuous reception long cycle; and
monitoring the downlink channel in the discontinuous reception short cycle according to the second monitoring parameter, wherein
a duration of each monitoring according to the second monitoring parameter is different from a duration of each monitoring according to the first monitoring parameter.

2. The discontinuous reception method according to claim 1, wherein the duration of each monitoring according to the second monitoring parameter is shorter than the duration of each monitoring according to the first monitoring parameter.

3. The discontinuous reception method according to claim 1, wherein determining the second monitoring parameter when entering into the discontinuous reception short cycle in the discontinuous reception long cycle comprises one of the following:
determining the second monitoring parameter according to a preset numerical value when entering into the discontinuous reception short cycle in the discontinuous reception long cycle; or
determining the second monitoring parameter according to a preset proportion and the first monitoring parameter when entering into the discontinuous reception short cycle in the discontinuous reception long cycle.

4. (canceled)

5. The discontinuous reception method according to claim 1, wherein the first monitoring parameter and the second monitoring parameter respectively comprise at least one of the following:
a duration of an Onduration Timer, or
a duration of a drx-Inactivity Timer.

6. The discontinuous reception method according to claim 5, wherein the second monitoring parameter comprises the duration of the Onduration Timer, and the discontinuous reception method further comprises:
monitoring the downlink channel only in a time period corresponding to the Onduration Timer when receiving indication of needing to receive new information in the discontinuous reception short cycle.

7. The discontinuous reception method according to claim 1, wherein the discontinuous reception method further comprises:
receiving a mode adjusting instruction, wherein the mode adjusting instruction indicates determining the second monitoring parameter when entering into the discontinuous reception short cycle in the discontinuous reception long cycle.

8. The discontinuous reception method according to claim 1, wherein the discontinuous reception long cycle comprises a plurality of discontinuous reception short cycles, and determining the second monitoring parameter when entering into the discontinuous reception short cycle in the discontinuous reception long cycle comprises:
determining the second monitoring parameter when entering into a discontinuous reception short cycle meeting a preset condition in the discontinuous reception long cycle.

9. The discontinuous reception method according to claim 8, wherein the discontinuous reception short cycle meeting the preset condition comprises at least one of the following:
a short cycle after timeout of a drx-Inactivity Timer,
or a short cycle after receiving a control element of a medium access control layer.

10. The discontinuous reception method according to claim 1, wherein determining the second monitoring parameter when entering into the discontinuous reception short cycle in the discontinuous reception long cycle comprises:
determining the second monitoring parameter according to a signaling sent by a base station when entering into the discontinuous reception short cycle in the discontinuous reception long cycle, wherein
the signaling is comprised in at least one of:
a radio resource control message, or
a control element of a medium access control layer.

11. The discontinuous reception method according to claim 10,
wherein the signaling is comprised in the radio resource control message and the control element of the medium access control layer, and determining the second monitoring parameter according to the signaling sent by the base station comprises:
determining a plurality of second monitoring parameters according to the radio resource control message;
determining identification on an identification indication bit from the control element of the medium access control layer; and
determining the second monitoring parameter corresponding to the identification among the plurality of second monitoring parameters.

12.-22. (canceled)

23. An electronic device, comprising:
a processor; and
a memory, configured to store executable instructions of the processor, wherein
the processor is configured to:
monitor a downlink channel in a discontinuous reception long cycle according to a first monitoring parameter;
determine a second monitoring parameter when entering into a discontinuous reception short cycle in the discontinuous reception long cycle; and
monitor the downlink channel in the discontinuous reception short cycle according to the second monitoring parameter, wherein
a duration of each monitoring according to the second monitoring parameter is different from a duration of each monitoring according to the first monitoring parameter.

24. A non-transitory computer readable storage medium storing a computer program, wherein the program, when executed by a processor, implements steps in a discontinuous reception method comprising:
monitoring a downlink channel in a discontinuous reception long cycle according to a first monitoring parameter;
determining a second monitoring parameter when entering into a discontinuous reception short cycle in the discontinuous reception long cycle; and
monitoring the downlink channel in the discontinuous reception short cycle according to the second monitoring parameter, wherein
a duration of each monitoring according to the second monitoring parameter is different from a duration of each monitoring according to the first monitoring parameter.

25. The electronic device according to claim 23, wherein the duration of each monitoring according to the second monitoring parameter is shorter than the duration of each monitoring according to the first monitoring parameter.

26. The electronic device according to claim 23, wherein the processor is further configured to:
determine the second monitoring parameter according to a preset numerical value when entering into the discontinuous reception short cycle in the discontinuous reception long cycle; or
determine the second monitoring parameter according to a preset proportion and the first monitoring parameter when entering into the discontinuous reception short cycle in the discontinuous reception long cycle.

27. The electronic device according to claim 23, wherein the first monitoring parameter and the second monitoring parameter respectively comprise at least one of the following:
a duration of an Onduration Timer, or
a duration of a drx-Inactivity Timer.

28. The electronic device according to claim 27, wherein the second monitoring parameter comprises the duration of the Onduration Timer, and the processor is further configured to:
monitor the downlink channel only in a time period corresponding to the Onduration Timer when receiving indication of needing to receive new information in the discontinuous reception short cycle.

29. The electronic device according to claim 23, wherein the discontinuous reception long cycle comprises a plurality of discontinuous reception short cycles, and the processor is further configured to:
determine the second monitoring parameter when entering into a discontinuous reception short cycle meeting a preset condition in the discontinuous reception long cycle.

30. The electronic device according to claim 29, wherein the discontinuous reception short cycle meeting the preset condition comprises at least one of the following:
a short cycle after timeout of a drx-Inactivity Timer, or
a short cycle after receiving a control element of a medium access control layer.

31. The electronic device according to claim 23, wherein the processor is further configured to:
determine the second monitoring parameter according to a signaling sent by a base station when entering into the discontinuous reception short cycle in the discontinuous reception long cycle, wherein
the signaling is comprised in at least one of the following:
a radio resource control message, or
a control element of a medium access control layer.

32. The electronic device according to claim 31, wherein the signaling is comprised in the radio resource control message and the control element of the medium access control layer, and the processor is further configured to:
determine a plurality of second monitoring parameters according to the radio resource control message;
determine identification on an identification indication bit from the control element of the medium access control layer; and
determine the second monitoring parameter corresponding to the identification among the plurality of second monitoring parameters.
